(19) United States
(12) Patent Application Publication
(10) Pub. No.: US 2005/0189747 A1
(43) Pub. Date: Sep. 1, 2005

(54) Side curtain air bag device

(76) Inventors: Paresh S. Khandhadia, Troy, MI (US); Bruce A. Stevens, Oakland, MI (US)

Correspondence Address: L.C. Begin & Associates, PLLC, PMB 403, 510 Highland Avenue, Milford, MI, 48381, US

(21) Appl. No.: 11/067,028

(22) Filed: Feb. 25, 2005

Related U.S. Application Data
(60) Provisional application No. 60/548,252, filed on Feb. 27, 2004.

(51) Int. Cl. B60R 21/22

(52) U.S. Cl. 280/730.2

(57) ABSTRACT

A vehicle occupant protection system including an airbag module containing an elongated inflator and an elongated airbag is provided. The airbag contains a first and a second upper portion, and at least one lower or thoracic portion in fluid communication with at least one upper portion upon activation of the airbag.

### CROSS REFERENCE TO RELATED APPLICATIONS

This application claims the benefit of provisional application Ser. No. 60/548,252 filed on Feb. 27, 2004.

### BACKGROUND OF THE INVENTION

It is an ongoing challenge to manufacture vehicle occupant protection systems that maintain the required protection while yet minimizing the manufacturing costs and complexity. As is known in the art, many vehicle occupant protection systems utilize multiple airbag assemblies thereby increasing the manufacturing costs as the number of assemblies is increased. Integration of two or more assemblies into one assembly would therefore provide an improvement in the art by minimizing the associated costs.

### SUMMARY OF THE INVENTION

The above-referenced concerns are resolved by a vehicle occupant protection system that incorporates an airbag module or device for releasably housing a side curtain/thorax airbag and an airbag inflator. When deployed, the side curtain airbag extends along the length of a vehicle associated therewith. The airbag includes a first upper portion along the length thereof, a second upper portion contiguous and juxtaposed to the first upper portion, and a first lower or thoracic portion oriented vertically below the first upper portion upon inflation of the airbag, wherein the airbag when fully deployed provides fluid communication between each of the portions and inflatable protection for the head and the thorax of an occupant proximate thereto. An inflator is positioned within the airbag wherein upon activation of the airbag device, the inflator provides an inflation gas across the length of the airbag sufficient to inflate the airbag.

Stated another way, a vehicle occupant protection system including an airbag module containing an inflator and an elongated airbag is provided. The airbag contains a first and a second upper portion, or collectively an upper section coextensive with the airbag module, and at least one lower or thoracic portion in fluid communication with at least one upper portion upon activation of the airbag.

### BRIEF DESCRIPTION OF THE DRAWINGS

FIG. 1 exemplifies a typical side curtain airbag.

FIG. 2 exemplifies a side curtain airbag incorporating a thoracic section, in accordance with the present invention,

FIG. 3 exemplifies a linear inflator used to inflate the airbags of the present invention.

FIG. 4 illustrates various pressure curves resulting from various embodiments of the linear inflator of FIG. 3.

FIG. 5 illustrates various pressure curves resulting from various embodiments of the linear inflator of FIG. 3.

FIG. 6 exemplifies a vehicle occupant protection system in accordance with the present invention.

### DETAILED DESCRIPTION

The present invention provides a side curtain air bag 42 that combines the functions of curtain bags and side impact bags. The bag 42 is designed to provide cushioning to the head and thorax areas, as well as a physical barrier to prevent occupant ejection.

In many vehicle occupant protection systems, multiple airbags are typically employed to protect the occupant not only from frontal impacts, but also from side impact collisions. Accordingly, side curtain airbags are employed to protect the head and prevent occupant ejection-from the vehicle while separate bags are often additionally employed to protect the thorax region of the occupant during a side impact.

In accordance with the present invention, a vehicle occupant protection system contains an airbag 42 that functions as a restraining side curtain and also functions to protect the head and thorax region of the occupant. In the past, providing an inflator that could effectively inflate the size of the present airbag in the time required has been a challenge. Accordingly, multiple inflators were used to inflate multiple airbags as described above. However, with the advent of linear airbag inflators, it is now possible to employ larger single side curtain airbags that provide greater protection and functionality than prior side curtain airbags. Co-owned U.S. Pat. No. 6,805,377 and co-owned and co-pending U.S. application Ser. Nos. 10/662,771 and 11/034,892, each herein incorporated by reference, exemplify linear inflators contemplated for use with the present airbag. Other similarly structured inflators or other inflators that provide the equivalent inflation pressure across the length of the airbag are necessarily provided to result in the sustained amount of gas that is required to inflate a larger bag, and keep it inflated for a desired time, in a rollover accident. Gas generation or gas pressurization along the length of these pyrotechnic inflators provides the necessary inflation rate and the necessary sustained inflation for side curtain airbags, as per customer requirements.

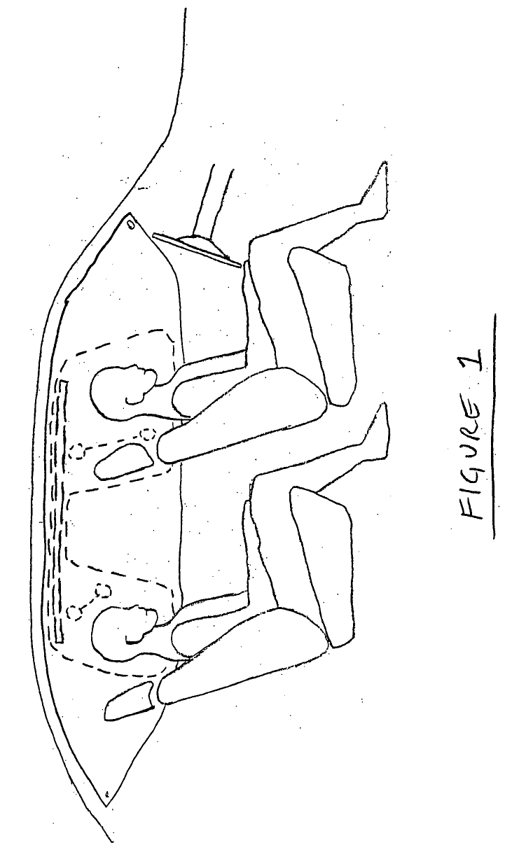

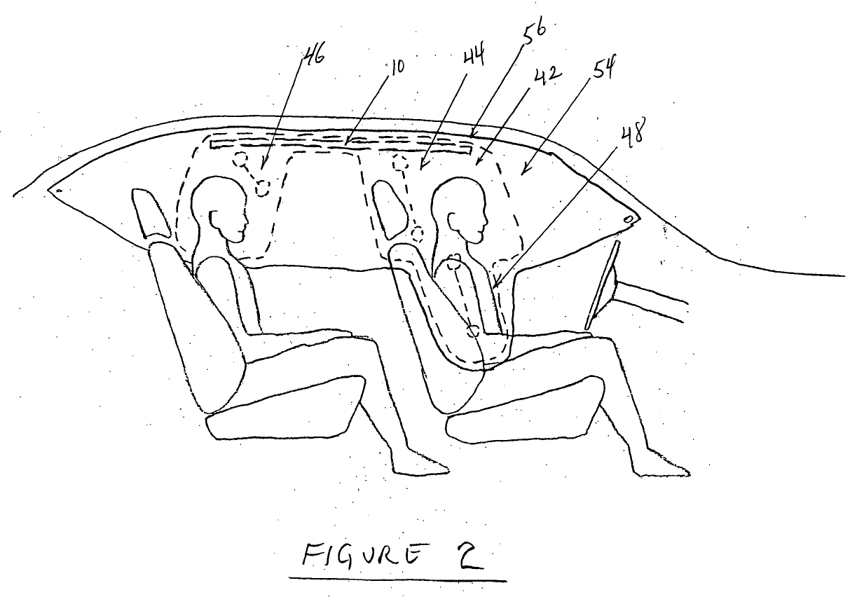

As shown in FIG. 1, prior art side curtain airbags generally protect the head of the occupant. As shown in FIG. 2, an airbag 42 is formed in accordance with the present invention and has at least one head protection portion 44 and at least one lower or thorax protection portion 48. A more preferred embodiment contains a first head protection portion 44, a second head protection portion 46 contiguous with and when inflated in fluid communication with the first head portion 44, and one or more lower or thorax portion(s) 48 extending from the first head portion 44 and in fluid communication therewith upon airbag activation.

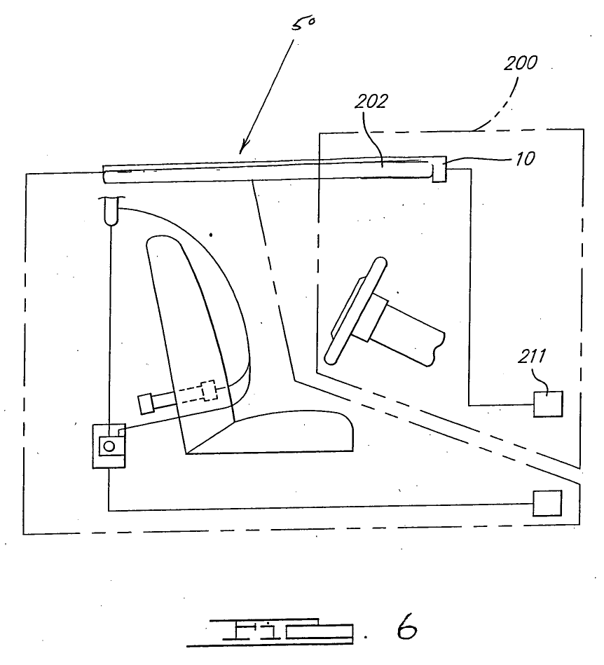

An airbag or side curtain 42 used in the present airbag module 50 or inflatable automotive restraint system may be constructed by known methods, by joining or sewing together one or more panels made from nylon, for example. Accordingly, a side curtain/thoracic restraint 42 may be partitioned in a known manner into a plurality of vertically oriented chambers that span across the length of the side curtain cushion 42. A linear inflator 10 as described above may be installed in a section internal of the airbag as schematically illustrated in FIG. 6, thereby providing direct fluid flow throughout the interior of the airbag 42 upon activation thereof. The side curtain/air bag 42 is more preferably constructed of a lightweight non-woven spunbonded olefin sheet, available under the proprietary name of Tyvek®, or preferably constructed of a cross laminated high-density polyolefin film, available under the proprietary name of Valeron®.

Valeron® is marketed by Van Leeer Flexibles, Inc. of Houston, Tex. and is made from high density oriented and cross-laminated polyethylene, and is stated as being puncture-resistant, tear-resistant, and chemical resistant. The preferred film is strong, with a smooth surface, balanced tear-resistance, and of uniform thickness. The film maintains its properties in harsh environments and has a temperature operating range from −70 to over 200 degrees Fahrenheit. The film is annealed or subjected to a higher temperature (from 35 degrees Celsius to just below the melting point of the plastic) thereby providing higher strength than unannealed counterparts.

Fabric particularly well-suited for airbag construction is spunbonded nonwoven polyolefin film-fibrils of the type disclosed in U.S. Pat. No. 3,169,899, herein incorporated by reference. Such spunbonded sheets preferably have been thermally bonded as disclosed in U.S. Pat. No. 3,532,589, herein incorporated by reference, or have been calendar bonded, as disclosed in PCT Publication No. WO 97/40224 and also herein incorporated by reference, in order to provide desired air barrier, water barrier, moisture vapor transmission, and strength properties. The term “polyolefin” is intended to mean any of a series of largely saturated open chain polymeric hydrocarbons composed only of carbon and hydrogen. Typical polyolefins include, but are not limited to, polyethylene, polypropylene, polymethylpentene, and various combinations of the monomers ethylene, propylene, and methylpentene. Other similarly engineered polymeric films will be apparent to those of ordinary skill in the art. U.S. Pat. Nos. 6,626,312, 6,579,584, 6,286,145, H1,989, 6,488,801, 6,364,341, 6,447,005, 6,641,896, and 6,355,333, all herein incorporated by reference, describe but do not limit exemplary and other suitable polymeric or plastic films that are useful in the present invention.

The porosity or gas permeability of the respective fabrics may be tailored by methods known in the art. Exemplary U.S. Pat. Nos. H1,989 and 6,488,801 describe methods to tailor the porosity from zero permeability to various greater permeabilities thereby facilitating a venting advantage in the presence of a desired porosity.

The seams of a preferred airbag or side curtain constructed as described above may be sealed using an EVA type hot melt adhesive, or an acrylic adhesive or tape, or a low density polyethylene heat seal, for example. As such, the labor intensive sewing of the airbag panel(s) is not required thereby again providing a significant manufacturing and performance advantage given the ease of sealing and given the elimination of the possibility of gas leakage through the seam(s).

In general, a preferred airbag may be constructed of a relatively lighter and thinner fabric than from airbag fabrics generally used in the art. As such, the lightweight airbag is more readily folded and the packing density is decreased thereby requiring an overall smaller package size, and thus providing significant assembly and manufacturing advantages. Regardless of the material of the airbag, it is folded or compressed in a known manner to fit within an airbag module 50 assembled within and along the upper side trim of a respective vehicle as schematically shown in FIG. 6, as is also known in the art.

However constructed, a preferred finished airbag 42 contains a front or first upper portion 44, and a rear or second upper portion 46 contiguous with the first portion, that when deployed extend along the length and across the B-pillar of an associated vehicle thereby providing a roll-over protection and a cushion for upper extremities of an occupant's body such as the head. When deployed, the third lower thoracic portion 48 is forcefully positioned adjacent a front door panel immediately below a window 54 contained within the door 56. Accordingly, when the airbag 42 is deployed, the upper and lower portions are inflated to provide both upper and lower protection for an occupant situated proximate thereto. If desired, the airbag 42 may contain a fourth lower thoracic section (not shown) extending below a rear window of a rear door thereby providing the same protection for an occupant seated in the back seat of a respective vehicle.

In sum, the airbags described herein are preferably formed from known materials and by known processes. Exemplary suitable airbag materials and manufacturing methods are set forth in U.S. Pat. Nos. 6,632,753, 6,458,725 and 5,044,663 and U.S. patent application Publication Nos.: 2003/0148683, 2003/0129339, 2003/0104226, 2003/0060103 and 20020155774. Each listed reference is hereby incorporated by reference in its entirety.

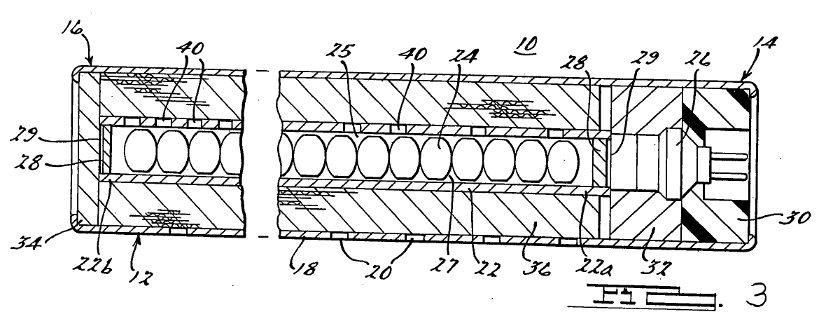

FIG. 3 shows a cross-sectional view of an inflator 10 in accordance with the present invention. Inflator 10 is preferably constructed of components made from a durable metal such as carbon steel or iron, but may also include components made from tough and impact-resistant polymers, for example. One of ordinary skill in the art will appreciate various methods of construction for the various components of the inflator. U.S. Pat. Nos. 5,035,757, 6,062,143, 6,347,566, U.S. patent application Ser. No. 2001/0045735, WO 01/08936, and WO 01/08937 exemplify typical designs for the various inflator components, and are incorporated herein by reference in their entirety, but not by way of limitation.

Referring to FIG. 3, inflator 10 includes a tubular housing 12 having a pair of opposed ends 14, 16 and a housing wall 18. Housing 12 may be cast, stamped, extruded, or otherwise metal-formed. A plurality of gas exit apertures 20 are formed along housing wall 18 to permit fluid communication between an interior of the housing and an airbag (not shown).

A longitudinal gas generant enclosure 22 is inwardly radially spaced from housing 12 and is coaxially oriented along a longitudinal axis of the housing. Enclosure 22 has an elongate, substantially cylindrical body defining a first end 22a, a second end 22b, and an interior cavity for containing a gas generant composition 24 therein. Enclosure first end 22a is positioned to enable fluid communication between an igniter 26 and the enclosure interior cavity. Enclosure 22 is configured to facilitate propagation of a combustion reaction of gas generant 24 along the enclosure, in a manner described in greater detail below.

In a preferred embodiment, a plurality of gas generant tablets 24 are stacked side by side along the length of enclosure 22. Each tablet 24 has substantially the same dimensions. In one embodiment, each gas generant tablet 24 has an outer diameter of ¼″ and a pair of opposing, generally dome-shaped faces 27, providing a maximum tablet width of approximately 0.165″ between faces. As seen in FIG. 3, tablets 24 are shaped or configured to advantageously create a cavity 25 between adjacent tablets 24. These cavities 25 provide a volume of air space relative within enclosure 22, thereby enhancing the burn characteristics of tablets 24 when they are ignited. An alternative arrangement of the gas generant along the length of the enclosure may be provided. However, any arrangement of gas generant along the enclosure preferably provides a substantially uniform average distribution of gas generant along the length of the enclosure. Examples of gas generant compositions suitable for use in the present invention are disclosed in U.S. Pat. Nos. 5,035,757, 6,210,505, and 5,872,329, incorporated herein by reference. However, the range of suitable gas generants is not limited to those described in the cited patents.

A quantity of a known auto-ignition composition 28 is positioned at either end of the stack of gas generant material 24. Enclosure 22 is environmentally sealed at both ends with an aluminum tape 29 or any other effective seal.

An igniter 26 is secured to inflator 10 such that the igniter is in communication with an interior of gas generant enclosure 22, for activating the inflator upon occurrence of a crash event. In the embodiment shown, igniter 26 is positioned within an annular bore of an igniter closure 30. Igniter 26 may be formed as known in the art. One exemplary igniter construction is described in U.S. Pat. No. 6,009,809, herein incorporated by reference.

Igniter closure 30 is crimped or otherwise fixed to a first end 14 of housing 12. A first endcap 32 is coaxially juxtaposed adjacent igniter closure 30 to form, in conjunction with igniter closure 30, an inner housing for igniter 26. First endcap 32 also provides a closure for gas generant enclosure 22. A second endcap 34 is crimped or otherwise fixed to a second end 16 of housing 12. Endcaps 32 and 34 and igniter closure 30 may be cast, stamped, extruded, or otherwise metal-formed. Alternatively, endcaps 32 and 34 may be molded from a suitable polymer.

A filter 36 may be incorporated into the inflator design for filtering particulates from gases generated by combustion of gas generant 24. In general, filter 36 is positioned between gas generant 24 and apertures 20 formed along inflator housing wall 18. In the embodiment shown in FIG. 3, filter 36 is positioned exterior of gas generant enclosure 22 intermediate enclosure 22 and housing wall 18, and substantially occupies the annular space between gas generant enclosure 22 and housing wall 18. In an alternative embodiment (not shown), filter 36 is positioned in the interior cavity of enclosure 22 between gas generant 14 and enclosure gas exit apertures 40 formed along enclosure 22. The filter may be formed from one of a variety of materials (for example, a carbon fiber mesh or sheet) known in the art for filtering gas generant combustion products.

In accordance with a preferred embodiment, a plurality of gas exit apertures 40 is particularly formed along enclosure 22 to tailor the rate of propagation of a combustion reaction of the gas generant 24 along the enclosure, as required by design criteria. Apertures 40 are spaced apart along enclosure 22 as described in greater detail below. Enclosure 22 may be roll formed from sheet metal and then perforated to produce apertures 40. Enclosure apertures 40 are environmentally sealed with an aluminum tape 42 or any other effective seal.

The effects of the sizes of enclosure apertures 40 and the spacing between the apertures on combustion propagation were studied by constructing a number of inflators substantially as shown in FIG. 3. Multiple groups of apertures 40 were formed along each enclosure 22, with the sizes and spacing of the apertures varying in a predetermined manner within each group as described below, beginning at the end of inflator 10 proximate igniter 26.

### EXAMPLE 1

A first group of 23 apertures having a 4.0 mm diameter and spaced one inch on center (OC) was first linearly formed, and then a second group of 48 apertures having a 4.0 mm diameter and spaced ½″ OC were formed collinear with the first group of apertures.

### EXAMPLE 2

A first group of 16 apertures having a 4.0 mm diameter and spaced one inch on center (OC) were first linearly formed; next a second group of 51 apertures having a 4.0 mm diameter and spaced ½″ OC were formed collinear with the first group of apertures; and finally a third group of 20 apertures having a 5.0 mm diameter and spaced ¼″ OC were formed collinear with the first and second groups of apertures.

### EXAMPLE 3

A first group of 12 apertures having a 4.0 mm diameter and spaced one inch on center (OC) were first linearly formed; next a second group of 47 apertures having a 4.0 mm diameter and spaced ½″ OC were formed collinear with the first group of apertures; and finally a third group of 45 apertures having a 5.0 mm diameter and spaced ¼″ OC were formed collinear with the first and second groups of apertures.

### EXAMPLE 4

A first group of 12 apertures having a 4.0 mm diameter and spaced one inch on center (OC) were first linearly formed; next a second group of 23 apertures having a 4.0 mm diameter and spaced ½″ OC were formed collinear with the first group of apertures; and finally a third group of 91 apertures having a 5.0 mm diameter and spaced ¼″ OC were formed collinear with the first and second groups of apertures.

The term “on center” is defined to be from the center point of one orifice to the center point of an adjacent orifice. The size of the holes or gas exit apertures preferably ranges from about one millimeter to about one-half the diameter of the propellant tube. Holes smaller than one millimeter are often difficult to manufacture with consistent size and with the desired efficiency. Holes or gas exit apertures larger than half the diameter of the propellant tube weaken the structure of the tube and are therefore relatively difficult to produce.

The gas exit apertures are preferably spaced about six millimeters to 26 millimeters on center. A spacing less than about 6 mm may weaken the structure, and presents a further structural concern if the local or associated gas exit aperture size is relatively large or close to the diameter of the propellant tube. Spacing larger than 26 mm may be employed although the efficiency of the cooling screen may consequently be reduced.

As such, the present invention incorporates a tailored overall surface area dependent on both the size and spacing of the gas exit apertures. The overall surface area may be tailored based on various design criteria such as the composition of the gas generant and/or the desired inflation profile of an associated airbag, for example. The distribution of the overall surface area from a relatively lower aperture area within the first half of the propellant tube (that is the half closest or adjacent to the ignition source) to a relatively larger aperture area within the second half of the propellant tube (that is the half of the propellant tube farthest from the ignition source) provides the desired combustion propagation across the length of the tube.

The percentage of the total surface area as a function of the position of the holes from the ignition source is tabulated and exemplified below. The open area is defined as the sum of the area of each hole in the propellant tube. Starting with a known example of equally spaced holes of equal size, the orifice area is equally distributed throughout the length of the propellant tube. An inflator designed as such results in the fastest propagation time and the shortest burnout time, or, the time required to completely combust the gas generant. As shown in Examples 1 through 4, the share of the aperture/orifice area at the ignition end of the tube is relatively smaller while the share of the orifice area at the opposite end of the ignition tube is relatively larger. This causes a proportional increase in the time it takes for the entire propellant stack to ignite and therefore affects the initial combustion rate and the duration of gas generation.

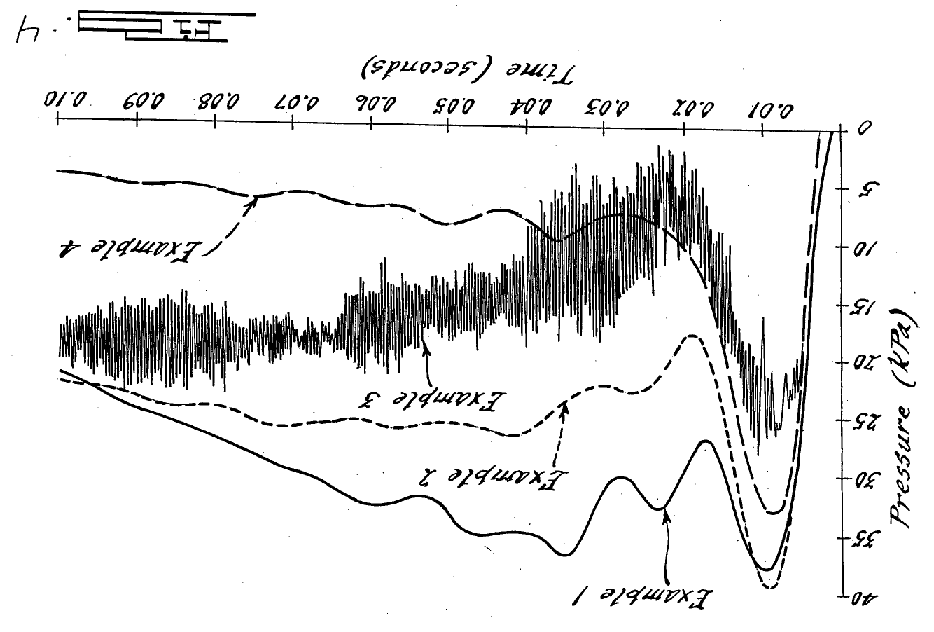

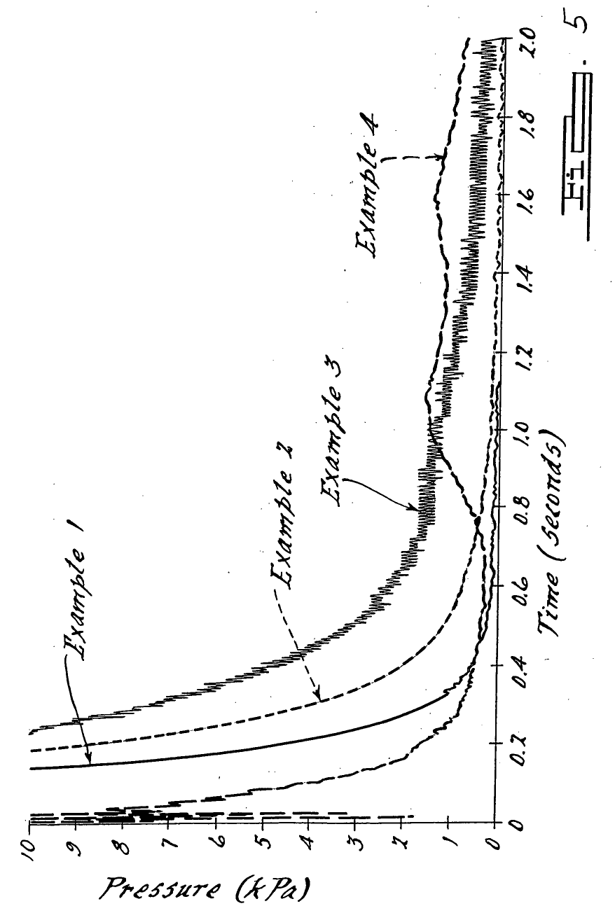

Each of the inflators was then activated, and the resulting airbag inflation pressure measured over the first few seconds of inflation. FIG. 4 graphically represents the resulting airbag inflation pressures during the first 0.1 second after inflator activation. FIG. 5 graphically represents the airbag inflation pressures during the first two seconds after inflator activation.

Based on these measurements and on laboratory analysis, it is believed that after initiator 26 is activated, the propagation rate of the combustion reaction along the enclosure is dependent upon the number of apertures 40 and the spacing between the apertures along enclosure 22. More specifically, it is believed that, along the sections of the enclosure where the aperture spacing is 1″ OC, the combustion reaction propagates via hot gases because the pressure inside this portion of the enclosure is relatively high due to the relative shortage of apertures to relieve the pressure; thus, there is a driving pressure force urging the hot gases further down the enclosure. In the sections where the aperture spacing is ½″ OC, the combustion reaction still propagates via hot gases but at a slower rate because the internal pressure is relatively lower, due to the shorter distance between apertures. In the sections where the aperture spacing is ¼″ OC, apertures 40 are relatively numerous, permitting the enclosure internal pressure to be more easily relieved; thus, there is minimal driving pressure force urging the hot gases further down the length of the enclosure. In this case, the combustion reaction continues to propagate at a relatively slower rate as each tablet 24 ignites the next adjacent tablet as it burns.

Thus, from an analysis of the above examples, it is believed that a relatively greater spacing between enclosure apertures 40 produces a correspondingly greater pressure within enclosure 22, resulting in a more rapid propagation (via hot gases) of the combustion reaction along the portion of the gas generant residing between the spaced-apart apertures. The more rapid propagation of the combustion reaction results in a more rapid burning of the gas generant and, thus, a more rapid generation of inflation gas, and more rapid inflation of an associated airbag, for example. Therefore, to affect the propagation rate of a combustion reaction along a portion of the enclosure, the apertures along the portion of the enclosure may be spaced apart a distance proportional to a desired rate of propagation of a combustion reaction of gas generant positioned between the apertures. The examples therefore illustrate how the combustion propagation rate may be tailored using an appropriate arrangement of enclosure apertures, to accommodate greater or lesser desired airbag inflation rates, and also to accommodate desired shorter or longer inflation durations. It should be appreciated that the type of propellant or gas generant composition 24 employed, for example those described in U.S. Pat. Nos. 5,035,757, 5,872,329, and 6,210,505, each herein incorporated by reference, may also be determinative of the desired combustion propagation rate across the length of the propellant tube 22. Accordingly, the propellant employed will affect the aperture open area along the length of the propellant tube. As different propellants are employed, the “aperture open area/unit length of the propellant tube” may be iteratively determined by experimental methods to produce the desired propagation rate across the length of the enclosure or propellant tube. For example, propellant tubes containing the same propellant could be perforated with different open areas per unit length across the length of the propellant tube in accordance with the present invention, and then qualitatively and quantitatively evaluated for sustained combustion, combustion propagation, inflation profile of an associated airbag, gas generating duration, inflator pressure across the length thereof, and other design criteria.

Tailoring of the overall gas exit area by modifying the number and/or average size of the gas exit apertures across a portion of the inflator length will determine the inflation profile across the respective portion. By tailoring the pressure drop across a respective portion, a greater volume may be inflated in the time required, a volume defined by an upper portion combined with a lower thoracic portion of an airbag restraint, for example. It will be appreciated that each airbag design utilizing a known inflator may be iteratively evaluated to accommodate a suitable inflation profile that provides the required inflation of the airbag in the desired time. The table given below illustrates this concept.

TABLE
Exemplary Open Area Percentages for Respective Sectional
Lengths of the Propellant Tube

| | | Second 25% | | |
|---|---|---|---|---|
| | First 25% of | of Prop. | Third 25% | Fourth 25% |
| | Prop. Tube | Tube | of | of Prop. Tube |
| | Length | Length (next | Prop. Tube | Length |
| | (closest to | to second | Length (next | (farthest from |
| | initiator end) | end). | to third end). | initiator end). |
| Equally | 25% | 25% | 25% | 25% |
| Spaced and | | | | |
| Sized Holes | | | | |
| Example 1 | 17% | 18% | 34% | 31% |
| Example 2 | 12% | 19% | 24% | 44% |
| Example 3 | 9% | 19% | 18% | 54% |
| Example 4 | 7% | 13% | 43% | 37% |

Preferred ranges for the percentage of the total aperture areas of each section of the propellant tube are as follows:
First 25% of Propellant Tube Length (Closest to the Initiator)—about 7-25%;
Second 25% of Propellant Tube Length—about 13-25%;
Third 25% of Propellant Tube Length—about 18-43%; and
Fourth 25% of Propellant Tube Length—25-54%.

In view of the data given above, the present invention includes a propellant tube 22 having a plurality of gas exit apertures 40 wherein the area of each hole is calculated and a total open aperture area or sum is calculated by adding the gas exit aperture areas together. A first perforated section 23 or portion of the propellant tube 22 is fixed closest to the igniter 26, wherein the first portion 23 includes less than half of the total open aperture area. A second perforated section 25 or portion of the propellant tube 22 is integral to and in coaxial relation with the first portion 23, wherein the second portion 25 includes more than half of the total open aperture area. As exemplified in the table given above, the first portion 23 may include up to 75% of the total length of the propellant tube 22, for example. On the other hand, the second portion 25 may include as little as 25% of the total length of the propellant tube 22, for example. It should be appreciated that in a preferred embodiment, the first half 27 of the tube 22 will contain less than half of the total open aperture area, and the second half 29 of the propellant tube 22 will contain more than half of the total open aperture area. As discussed above, the respective first and second gas exit aperture areas of either the first or second sections may be tailored by the number and size of respective gas exit apertures included in either section.

Accordingly, consistent with the table given above, the present invention may also be characterized as an elongated inflator 10 comprising a plurality of collinear and integral sections that together constitute a single perforated tube 22. As such, in this embodiment, a first section nearest to an associated igniter, a second section juxtaposed to the first section, a third section juxtaposed to the second section, and a fourth section farthest from the igniter and juxtaposed to the third section constitute the propellant tube internal to the inflator. More generally, a preferred embodiment includes an elongated housing 12 that contains an elongated propellant tube 22 substantially coextensive therewith. A first end 28 of the propellant tube 22 is fixed to an associated igniter 26. A second end 33 of the propellant tube 22 is preferably capped to seal off the flow of combustion gases upon inflator 10 activation. A plurality of gas exit orifices 40 is formed within the propellant tube 22 from the first end to the second end. As supported in the table shown above relative to overall open aperture area, the number and/or size of the apertures may increase per unit length from the first end to the second end, thereby providing a uniform inflation profile across the overall length of the inflator 10.

It is noted that the stacking of substantially uniform gas generant tablets 24 adjacent each other along enclosure 22 provides for a relatively constant average density of gas generant along the enclosure. Also, the use of an enclosure having a substantially constant cross-sectional area along the length of the enclosure provides for a substantially constant volume per unit length of the enclosure. These features aid in minimizing pressure variations within the enclosure due to such factors as variations in enclosure volume, and localized hot spots and higher pressure regions resulting from disparities in gas generant distribution along the enclosure. The dome-shaped faces of each propellant tablet further facilitates an ease of assembly in that each dome-shaped face provides a pivot point at its apex that physically communicates with the apex of an adjacent tablet's propellant face. Accordingly, by virtue of the pivot point created on each dome-shaped face, the same juxtaposed orientation of each propellant tablet is assured without undue complication.

In addition, it may be seen (particularly from FIGS. 4 and 5) that the airbag pressure measured in each Example decreases markedly from an initial peak value within approximately 0.02 seconds of inflator activation. It may also be seen that the magnitude of the initial pressure drop is relatively smaller for the inflator of Example 1 and relatively greater for the inflator of Example 4. It is believed that the magnitude of this pressure drop is related to the total number of apertures along the respective gas generant enclosure. The gas generant enclosure of Example 1 has a total of 71 apertures formed therealong, while the enclosure of Example 4 has a total of 126 apertures formed therealong. It is believed that the greater number of apertures along the enclosure of Example 4, spaced along a greater length of the respective enclosure, provides a greater total aperture area for relief of enclosure internal pressure. Thus, the greater number of apertures along the gas generant enclosure of Example 4 may serve to reduce the combustion propagation rate relative to the enclosure of Example 1, because of the relatively larger drop in the enclosure. Therefore, to affect the propagation rate of a combustion reaction along a portion of the enclosure, the number of apertures provided along the portion of the enclosure is made inversely proportional to a desired rate of propagation of a combustion reaction along the gas generant positioned between the apertures.

Referring now to FIG. 6, an inflator constructed in accordance with the principles outlined above may be incorporated into a vehicle occupant restraint system 200 as schematically shown. Vehicle occupant restraint system 200 includes at least one airbag 202 formed in accordance with the present invention, and an inflator 10 coupled to airbag 202 so as to enable fluid communication with an interior of the airbag. Vehicle occupant restraint system 200 is typically in operative communication with a crash event sensor 211 manufactured in a known manner which communicates with a known crash sensor algorithm that signals actuation of vehicle occupant restraint system 200 via, for example, activation of airbag inflator 10 in the event of a collision. Other components such as a seatbelt assembly formed in a known manner and other airbag assemblies (not shown) may be further incorporated into the vehicle occupant restraint system 200 as known in the art.

It will be understood that the foregoing description of the preferred embodiment(s) of the present invention is for illustrative purposes only. As such, the various structural and operational features herein disclosed are susceptible to a number of modifications commensurate with the abilities of one of ordinary skill in the art, none of which departs from the scope of the present invention as defined in the appended claims.

1. An airbag device within a side curtain airbag module of a vehicle, the airbag device comprising:
an airbag comprising a first upper portion along a length thereof, a second upper portion contiguous and juxtaposed with said first upper portion, and at least one thoracic portion oriented vertically below said first upper portion upon inflation of said airbag, wherein said airbag when fully deployed provides inflatable protection for the head and the thorax of an occupant proximate thereto.

2. The airbag device of claim 1 further comprising:
an inflator positioned within said airbag wherein upon activation of said airbag device, said inflator provides an inflation gas across the length of said airbag sufficient to inflate said airbag.

3. A vehicle occupant protection system comprising:
an airbag module for releasably housing an airbag and an airbag inflator;
an airbag fixed within said airbag module, said airbag comprising a first upper portion along a length thereof, a second upper portion contiguous and juxtaposed with said first upper portion, and a first thoracic portion oriented vertically below said first upper portion upon inflation of said airbag, wherein said airbag when fully deployed provides inflatable protection for the head and the thorax of an occupant proximate thereto; and
an inflator positioned within said airbag wherein upon activation of said airbag device, said inflator provides an inflation gas across the length of said airbag sufficient to inflate said airbag.

4. A side curtain airbag module contained within a vehicle along a length thereof, the module comprising:
an airbag inflator; and
an airbag formed with an upper portion extending along said length and at least one lower portion extending below said upper portion,
wherein said inflator fluidly communicates with said airbag upon inflator activation thereby pressurizing both the upper and lower portions of said airbag.

5. The side curtain airbag module of claim 4 wherein said airbag inflator extends along the length of said vehicle and is substantially coextensive with said airbag.
